(19) United States
(12) Patent Application Publication
(10) Pub. No.: US 2011/0133492 A1
(43) Pub. Date: Jun. 9, 2011

(54) VEHICLE DOOR LATCH

(76) Inventors: Donald M. Perkins, Sterling Heights, MI (US); Francisco J. Lujan, Juarez (MX); Carlos I. Tostado, Juarez (MX)

(21) Appl. No.: 12/633,484

(22) Filed: Dec. 8, 2009

(51) Int. Cl. E05C 3/06; E05C 17/04

(52) U.S. Cl. 292/216; 292/262

(57) ABSTRACT

A vehicle door latch assembly is provided, the latch assembly having: a release lever rotatably secured to the latch assembly, the release lever being capable of being moved between a latched position and an unlatched position; an actuating link rotatably secured to the latch assembly; a bypass member rotatably secured to the latch assembly; and wherein the actuating link is capable of linear movement such that a center of rotation of the actuating link is movable between a first position and a second position and wherein the actuating link couples the release lever to the bypass member when the center of rotation of the actuating link is in the first position and the actuating link does not couple the release lever to the bypass member when the center of rotation of the actuating link is in the second position. A method for coupling a release lever of a latch assembly to a bypass lever of the latch assembly is also provided.

### BACKGROUND

Exemplary embodiments of the present invention relate to door and movable panel latches and, more particularly, to door and movable panel latches for vehicles.

A vehicle frequently includes displaceable panels such as doors, hood, trunk lid, hatch and the like which are affixed for hinged or sliding engagement with a host vehicle body. Cooperating systems of latches and strikers are typically provided to ensure that such panels remain secured in their fully closed position when the panel is closed.

A child security or child lock mechanism is a feature found on certain vehicle doors of most late model vehicles. The purpose of this feature is to protect a child from inadvertently unlocking and opening the door that could lead to a safety hazard. Typically, an inside release handle is located on an inner trim panel of the door and is connected to a release mechanism of the latch via a rod or cable. The movement of the inside release handle causes the latch to open or unlock via the cable or rod secured to the insider release handle.

In order to provide a child security or child lock mechanism it is desirable to provide a mechanism for decoupling and subsequent coupling of the inside release handle to the door latch mechanism. Furthermore, it is also desirable to provide a child security or child lock mechanism that is robust and uses a minimal amount of components while also providing a compact design.

### SUMMARY OF THE INVENTION

In accordance with an exemplary embodiment of the invention, a vehicle latch assembly is provided. The latch assembly having: a release lever rotatably secured to the latch assembly, the release lever being capable of being moved between a latched position and an unlatched position; an actuating link rotatably secured to the latch assembly; a bypass member rotatably secured to the latch assembly; and wherein the actuating link is capable of linear movement such that a center of rotation of the actuating link is movable between a first position and a second position and wherein the actuating link couples the release lever to the bypass member when the center of rotation of the actuating link is in the first position and the actuating link does not couple the release lever to the bypass member when the center of rotation of the actuating link is in the second position.

In accordance with another exemplary embodiment of the present invention, a method for coupling a release lever of a latch assembly to a bypass lever of the latch assembly is provided, the method including the steps of: rotatably securing a release lever to the latch assembly for movement about an axis between a latched position and an unlatched position; rotatably securing a bypass member to the latch assembly for movement about the axis; and linking the release lever to the bypass member with an actuating link rotatably secured to the latch assembly, wherein the actuating link is capable of linear movement such that a center of rotation of the actuating link is movable between a first position and a second position and wherein the actuating link couples the release lever to the bypass member when the center of rotation of the actuating link is in the first position and the actuating link does not couple the release lever to the bypass member when the center of rotation of the actuating link is in the second position.

Still other exemplary embodiments of the present invention are directed to mechanisms for decoupling and coupling release or other types of levers/mechanisms in which the two coupled and uncoupled components pivot or rotate about the same axis or center of rotation.

Additional features and advantages of the various aspects of exemplary embodiments of the present invention will become more readily apparent from the following detailed description in conjunction with the drawings wherein like reference numerals refer to corresponding parts in the several views.

### BRIEF DESCRIPTION OF THE DRAWINGS

FIG. 1 is a view illustrating a latch assembly in a closed or primary latched position with a linking mechanism or child lock in a disengaged position in accordance with an exemplary embodiment of the present invention;

FIG. 2 is an opposite side view illustrating the latch assembly of FIG. 1;

FIG. 3 is a view illustrating the latch assembly of FIG. 1 in an open or unlatched position in accordance with an exemplary embodiment of the present invention;

FIG. 4 is a view illustrating the latch assembly of FIG. 1 in a closed or primary latched position with the linking mechanism or child lock in an engaged position in accordance with an exemplary embodiment of the present invention;

FIG. 5 is a view illustrating a release lever of the latch assembly of FIG. 1 moved to an open or unlatched position while an unlatching lever of the latch assembly remains in the latched or closed position thereby retaining the latch assembly in a closed position; and

FIGS. 6-13 illustrate a linking mechanism for coupling and decoupling of an inside release handle with an unlatching lever of the latch assembly.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION OF EXEMPLARY EMBODIMENTS

Exemplary embodiments of the present invention relate to an apparatus and method for providing a latch assembly. Furthermore, exemplary embodiments are directed to a latch assembly having a linking mechanism for coupling and decoupling of an inside release handle with an unlatching lever or other equivalent component of the latch assembly.

As discussed above, various embodiments of the present invention provide a child security or child lock mechanism for decoupling and subsequent coupling of an inside release handle to the door latch mechanism such that when the child security or child lock mechanism is engaged movement of the release handle will not cause the latch to transition into an open state. Furthermore, it is also desirable to provide such a mechanism in a compact design.

Reference is made the following U.S. Pat. Nos. 6,811,193; 7,090,264; 5,520,426; 5,277,461; 5,316,354; 5,454,608; 4,969,673; 5,715,713; 5,535,607; 6,264,253; 6,749,234; and 6,733,052 the contents each of which are incorporated herein by reference thereto.

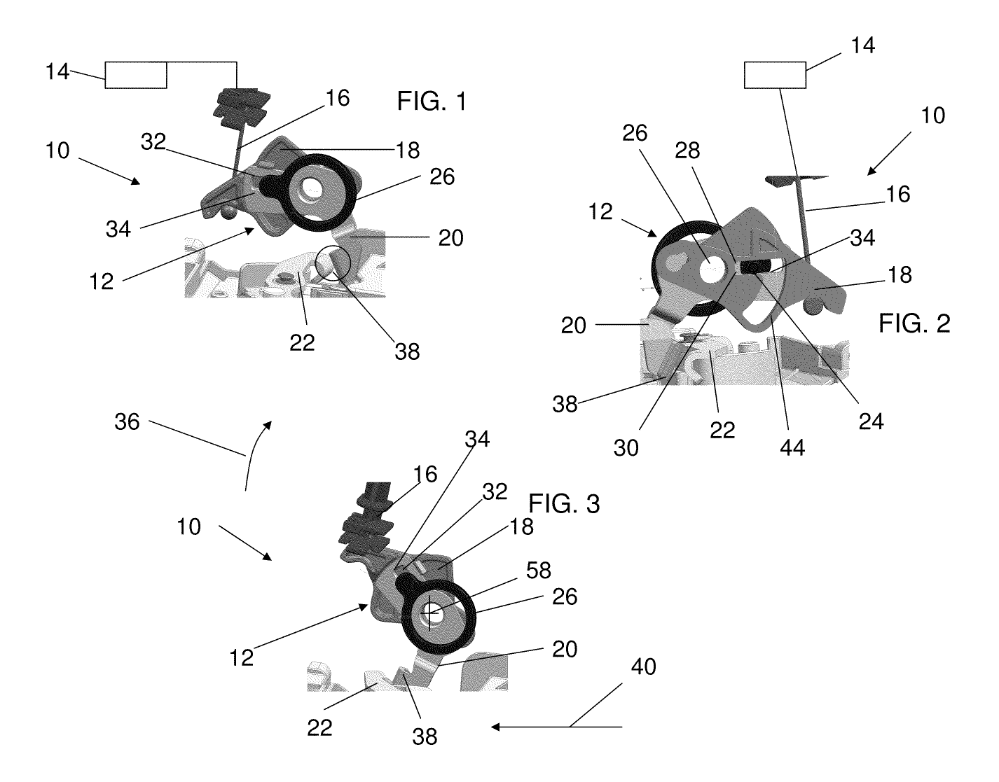

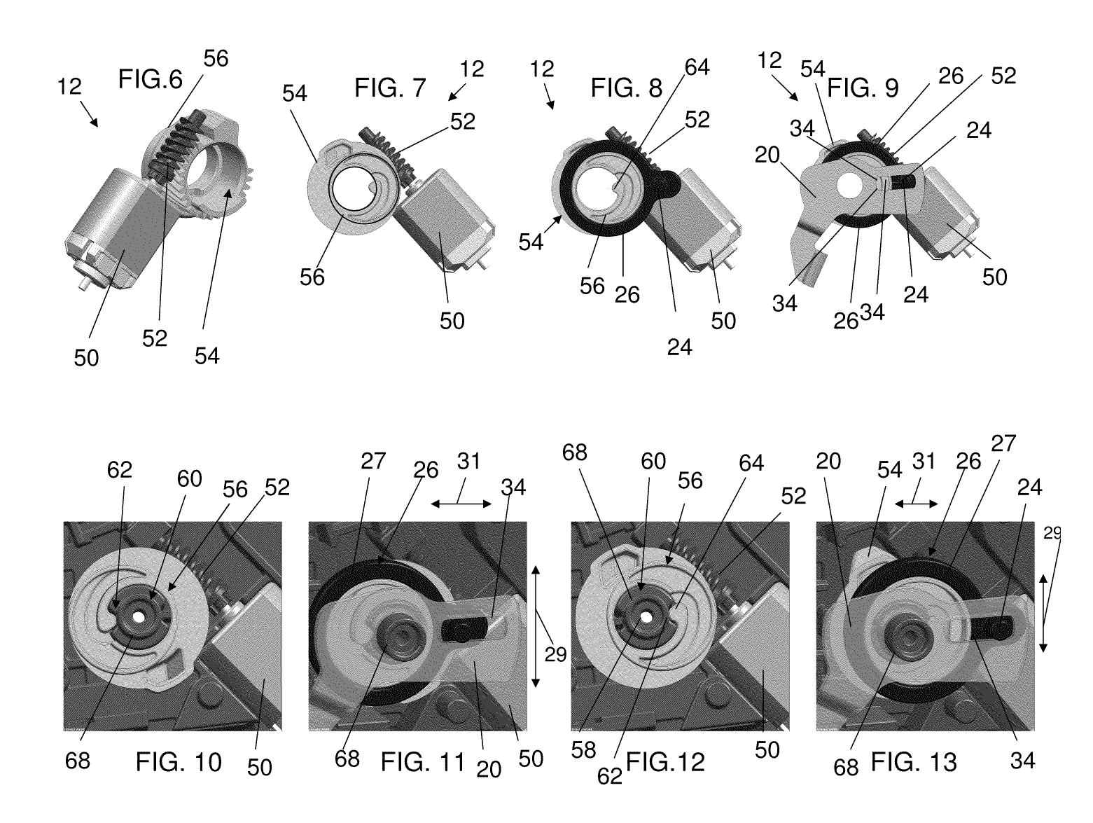

Referring now to FIGS. 1-8, a vehicle compartment latch or latch assembly 10 in accordance with an exemplary embodiment of the present invention is illustrated. Vehicle compartment latch or latch assembly 10 is adapted for fastening to a vehicle proximate to a compartment closure.

A forkbolt or forkbolt lever is pivotally or rotationally mounted to the latch assembly for rotational or pivotal movement between an open or unlatched position and a closed or latched position. In one mode of operation an inside handle lever indirectly or otherwise coupled to the forkbolt (as is known in the related arts) is moved to cause the forkbolt to translate or move from the latched or closed position to the open or unlatched position. In accordance with an exemplary embodiment of the present invention a linking mechanism or child security mechanism 12 is provided to couple and decouple the inside handle to the fork bolt of the latch assembly.

FIGS. 1-5 illustrate the components of a child security mechanism 12 integrated into a vehicle side door latch in accordance with exemplary embodiments of the present invention. During operation a passenger would interface with an inside handle lever 14 illustrated schematically by box 14 and located on an inner panel of the vehicle door. When this handle is pulled, work is transferred to the latch assembly via a rod or cable or any other equivalent device 16. The cable, in this case, interfaces with an inside release lever 18 that is coupled to a bypass lever 20 by the linking mechanism 12.

If the child security feature or linking mechanism is not engaged or in a first position, these three levers (inside handle lever 14, release lever 18 and bypass lever 20) act as one and thus transfer work to an unlatching mechanism or unlatching lever 22, which is pivotally secured to the latch assembly. The movement of the unlatching lever will cause a forkbolt to transition from a closed or latched position to an open or unlatched position. The movement of the forkbolt to the open position would then release the vehicle door and allow for egress from the vehicle.

FIG. 2 shows the child security feature or linking mechanism in the disengaged position such that movement of the inside handle lever will be translated to the forkbolt thus opening the vehicle door latch. In the disengaged position a blocking pin 24 integral with an actuating link 26 of the child security feature or linking mechanism 12 is located in such a manner that the blocking pin will contact a drive surface 28 of a first slot or first opening portion 30 of an opening in the release lever and a drive surface 32 of an opening 34 in the bypass lever. Thus when the inside release lever is rotated or pulled, work is transferred to the bypass lever through the block out pin of the actuating link as shown in FIG. 3.

As illustrated, the release lever, the actuating link and the bypass lever are rotated in the direction of arrow 36 and a contact surface 38 of the bypass lever is moved in the direction of arrow 40 thus moving unlatching lever 22.

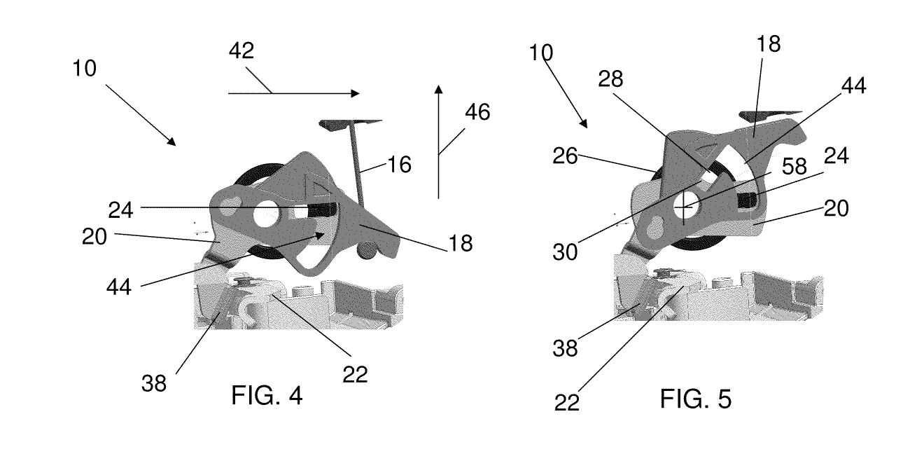

Referring now to FIG. 4 the linking mechanism 12 is shown in the engaged position or a second position. In this position, the actuating link 26 is translated in the direction of arrow 42 such that the block out pin 24 is positioned in such a manner that no work is transferred to the bypass lever by the inside release lever. When the linking mechanism 12 is in the engaged position or a second position and the actuating link 26 is translated in the direction of arrow 42, the blocking pin is located in a second opening portion 44 of an opening in the release lever. The first opening portion 30 is coupled to the second opening portion 44 and the configuration and angular orientation of the openings 30 and 44 are such that as the actuating link 26 and pin 24 translate in the direction of arrow 42, the pin is positioned in opening portion 44 such that the release lever is allowed to rotate freely in the direction of arrows 36 and 46 via a clearance slot integral with the release lever defined by opening 44. Accordingly and when the release mechanism is in the second position the release lever is able to translate to the position depicted in FIG. 5 while no work is transferred to unlatching lever 22 such that when the release handle is moved the door remains closed. In other words and in this configuration, movement of the inside release handle will still cause release lever 18 to rotate however, movement of the release lever will not be translated to the bypass lever and the door will remain closed.

In order to translate or move the linking mechanism or child security latch from the disengaged position to the engaged position and vice versa a means for engaging and disengaging the linking mechanism or child security latch is provided. In one non-limiting exemplary embodiment, the means to engage and disengage the linking mechanism is an electric motor 50.

In one embodiment and to engage and disengage the linking mechanism electrically, the actuating link 26 will need to be able to translate linearly (in the direction of arrow 42 as well as a direction opposite to arrow 42) and still be allowed to rotate (in the direction of arrow 46 as well as a direction opposite to arrow 46) when required. In one exemplary embodiment and in order to translate the actuating link linearly the link is driven by electric motor 50 that rotates a worm gear 52 and subsequently a drive gear 54.

Integral to the drive gear is an eccentric ring portion 56 about which the actuating link pivots or rotates. This arrangement allows the drive gear to pivot or rotate upon the same axis 58 as the release lever 18 and the bypass lever, thus decreasing the required packaging space for the system.

In an exemplary embodiment and as the drive gear rotates, the block out pin translates within the first opening portion of the release lever and the guiding slot or opening of the bypass lever (e.g., from a first position to a second position and vice versa). As illustrated in at least FIGS. 11 and 13, the blocking pin of the actuating link is received within opening 34 of the bypass lever such that pin 24 rotates as well as slides therein. The rotational movement of the pin in opening 34 allows a ring portion 27 of the actuating link to rotate about eccentric ring 56 as well as move up and down in the directions of arrows 29 (e.g., ring pivots about the axis of pin 24) as the eccentric ring portion rotates about axis 58 and ring portion 27 rotates about ring portion 56. Accordingly and as the drive gear rotates, eccentric ring portion rotates about axis 58 and ring portion 27, which is rotatably received on eccentric ring portion 56 rotates and moves up and down in the directions of arrows 29 while blocking pin 24 moves linearly in the direction of arrows 31. This movement is due to the fact that eccentric ring portion 56 is off set from axis 58 about which drive 54 rotates. Accordingly, rotation of drive gear 54 causes pin 24 to slide within opening 34 of the bypass lever as well as opening portion 30 of the release lever (e.g., movement of the pin from the first position to the second position and vice versa).

Accordingly and by driving the motor in one direction the linking mechanism is engaged (e.g., movement of an inner release handle is not translated to the unlatching lever) and reversing the polarity of the motor will return the system to its original position (e.g., disengaged wherein movement of the inner release handle is translated to the unlatching lever and the door is opening). In one exemplary embodiment, the unique common pivot point and eccentric cam arrangement allows for optimum packaging of the linking mechanism and ultimately the latch while also providing efficient actuation.

FIGS. 10 and 11 illustrate the linking mechanism in the first position (child security disengaged, inner door handle pull opens door) while FIGS. 12 and 13 illustrate the linking mechanism in the second position wherein the drive gear has been rotated 180 degrees with respect to the position in FIGS. 10 and 11 so that the eccentric ring portion has moved from being predominately to the left of axis 58 (FIGS. 10 and 11) to being predominately to the right of axis 58 (FIGS. 12 and 13) and the child security feature is engaged (e.g., inner door handle pull does not open door). Although 180 degrees of rotation are illustrated and described it is, of course, understood that ranges of rotation greater or less than 180 degrees are contemplated to be within the scope of exemplary embodiments of the present invention.

Furthermore, integrated into a pivot portion 60 of the drive gear, is a detenting feature 62 that engages a complimentary feature 64 of the eccentric ring portion. Pivot portion 60 further comprises an extended shaft portion 68 that extends outwardly from the pivot and provides a pivot point as well as axis 58 for the bypass lever and the release lever.

The engagement of features 62 and 64 will resist unwanted movement of the system when the motor is de-energized. In addition, the engagement of features 62 and 64 will ensure the proper alignment of the block out pin.

As illustrated, the center of the shaft portion 68 is aligned with axis 58 and eccentric ring portion also rotates about axis 58 thus providing the compact arrangement of an exemplary embodiment of the present invention.

Although specific embodiments illustrate child security mechanisms it is, of course, understood that exemplary embodiments of the present invention also contemplate mechanisms for decoupling and coupling release or other types of levers/mechanisms in which the two coupled and uncoupled components pivot or rotate about the same axis or center of rotation.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A vehicle door latch assembly, comprising:
a release lever rotatably secured to the latch assembly, the release lever being capable of being moved between a latched position and an unlatched position;
an actuating link rotatably secured to the latch assembly;
a bypass member rotatably secured to the latch assembly; and
wherein the actuating link is capable of linear movement such that a center of rotation of the actuating link is movable between a first position and a second position and wherein the actuating link couples the release lever to the bypass member when the center of rotation of the actuating link is in the first position and the actuating link does not couple the release lever to the bypass member when the center of rotation of the actuating link is in the second position.

2. The vehicle door latch assembly as in claim 1, wherein the release lever is capable of rotational movement when the center of rotation of the linking mechanism is in the second position.

3. The vehicle door latch assembly as in claim 1, wherein the actuating link is rotatably secured to an eccentric ring portion of a drive gear rotatably secured to the latch assembly for rotation about the axis and wherein a center of the eccentric ring portion is off set from the axis such that as the drive gear rotates about the axis the eccentric ring rotates about the axis and the actuating link rotatably secured thereto translates linearly.

4. The vehicle door latch assembly as in claim 3, wherein the drive gear is rotated about the axis by a motor.

5. The vehicle door latch assembly as in claim 4, wherein a worm drive of the motor engages a toothed portion of the drive gear and the eccentric ring portion depends outwardly from the toothed portion of the drive gear.

6. The vehicle door latch assembly as in claim 1, wherein the actuating link has a ring portion and a blocking pin secured to the ring portion, wherein the blocking pin is rotatably received within an opening of the bypass lever such that the center of axis of the actuating link is capable of moving between the first position and the second position while the blocking pin slides linearly within the opening of the bypass lever.

7. The vehicle door latch assembly as in claim 6, wherein the actuating link is rotatably secured to an eccentric ring portion of a drive gear rotatably secured to the latch assembly for rotation about the axis and wherein a center of the eccentric ring portion is off set from the axis such that as the drive gear rotates about the axis the eccentric ring rotates about the axis and the actuating link rotatably secured thereto translates linearly.

8. The vehicle door latch assembly as in claim 1, wherein the actuating link has a ring portion and a blocking pin secured to the ring portion, wherein the blocking pin is movably received within an opening of the release lever such that as the center of axis of the actuating link is moved between the first position and the second position the blocking pin slides linearly between a first position and a second position within the opening of the release lever and when the blocking pin is within the first position within the opening of the release lever rotational movement of the release lever is translated to the bypass lever by the blocking pin and when the blocking pin is within the second position within the opening of the release lever rotational movement of the release lever is not translated to the bypass lever by the blocking pin.

9. The vehicle door latch assembly as in claim 8, wherein the actuating link is rotatably secured to an eccentric ring portion of a drive gear rotatably secured to the latch assembly for rotation about the axis and wherein a center of the eccentric ring portion is off set from the axis such that as the drive gear rotates about the axis the eccentric ring rotates about the axis and the actuating link rotatably secured thereto translates linearly.

10. The vehicle door latch assembly as in claim 8, wherein the opening of the release lever has a first opening portion and a second opening portion, the second opening portion being configured so that the blocking pin slides within the second opening of the release lever and rotational movement of the release lever is not translated to the bypass lever by the blocking pin.

11. The vehicle door latch assembly as in claim 1, wherein the release lever is rotatably secured to the latch assembly for rotation about an axis and the bypass is also rotatably secured to the latch assembly for rotation about the axis.

12. The vehicle door latch assembly as in claim 11, wherein the actuating link has a ring portion and a blocking pin secured to the ring portion, wherein the blocking pin is movably received within an opening of the release lever such that as the center of axis of the actuating link is moved between the first position and the second position the blocking pin slides linearly between a first position and a second position within the opening of the release lever and when the blocking pin is within the first position with the opening of the release lever rotational movement of the release lever is translated to the bypass lever by the blocking pin and when the blocking pin is within the second position with the opening of the release lever rotational movement of the release lever is not translated to the bypass lever by the blocking pin.

13. The vehicle door latch assembly as in claim 12, wherein the actuating link is rotatably secured to an eccentric ring portion of a drive gear rotatably secured to the latch assembly for rotation about the axis and wherein a center of the eccentric ring portion is off set from the axis such that as the drive gear rotates about the axis the eccentric ring rotates about the axis and the actuating link rotatably secured thereto translates linearly.

14. The vehicle door latch assembly as in claim 11, wherein the actuating link is rotatably secured to an eccentric ring portion of a drive gear rotatably secured to the latch assembly for rotation about the axis and wherein a center of the eccentric ring portion is off set from the axis such that as the drive gear rotates about the axis the eccentric ring rotates about the axis and the actuating link rotatably secured thereto translates linearly.

15. A method for coupling a release lever of a latch assembly to a bypass lever of the latch assembly, the method comprising:
rotatably securing a release lever to the latch assembly for movement about an axis between a latched position and an unlatched position;
rotatably securing a bypass member to the latch assembly for movement about the axis; and
linking the release lever to the bypass member with an actuating link rotatably secured to the latch assembly, wherein the actuating link is capable of linear movement such that a center of rotation of the actuating link is movable between a first position and a second position and wherein the actuating link couples the release lever to the bypass member when the center of rotation of the actuating link is in the first position and the actuating link does not couple the release lever to the bypass member when the center of rotation of the actuating link is in the second position.

16. The method as in claim 15, wherein the actuating link is rotatably secured to an eccentric ring portion of a drive gear rotatably secured to the latch assembly for rotation about the axis and wherein a center of the eccentric ring portion is off set from the axis such that as the drive gear rotates about the axis the eccentric ring rotates about the axis and the actuating link rotatably secured thereto translates linearly.

17. The method as in claim 15, wherein the actuating link has a ring portion and a blocking pin secured to the ring portion, wherein the blocking pin is rotatably received within an opening of the bypass lever such that the center of axis of the actuating link is capable of moving between the first position and the second position while the blocking pin slides linearly within the opening of the bypass lever.

18. The method as in claim 15, wherein the actuating link has a ring portion and a blocking pin secured to the ring portion, wherein the blocking pin is movably received within an opening of the release lever such that as the center of axis of the actuating link is moved between the first position and the second position the blocking pin slides linearly between a first position and a second position within the opening of the release lever and when the blocking pin is within the first position within the opening of the release lever rotational movement of the release lever is translated to the bypass lever by the blocking pin and when the blocking pin is within the second position within the opening of the release lever rotational movement of the release lever is not translated to the bypass lever by the blocking pin.

19. The method as in claim 15, wherein the release lever is rotatably secured to the latch assembly for rotation about an axis and the bypass is also rotatably secured to the latch assembly for rotation about the axis.

20. The method as in claim 19, wherein the actuating link has a ring portion and a blocking pin secured to the ring portion, wherein the blocking pin is movably received within an opening of the release lever such that as the center of axis of the actuating link is moved between the first position and the second position the blocking pin slides linearly between a first position and a second position within the opening of the release lever and when the blocking pin is within the first position with the opening of the release lever rotational movement of the release lever is translated to the bypass lever by the blocking pin and when the blocking pin is within the second position with the opening of the release lever rotational movement of the release lever is not translated to the bypass lever by the blocking pin.
